(19) United States
(12) Patent Application Publication
(10) Pub. No.: US 2008/0055772 A1
(43) Pub. Date: Mar. 6, 2008

(54) Method and apparatus for predicting contact of a read-write head in a hard disk drive

(76) Inventors: Chris McMillan, San Jose, CA (US); Umesh Chandra, Santa Cruz, CA (US); Yawshing Tang, Saratoga, CA (US); Xiaodong Che, Saratoga, CA (US); Hoyul Bang, Cupertino, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/698,751

(22) Filed: Jan. 26, 2007

Related U.S. Application Data
(60) Provisional application No. 60/841,857, filed on Sep. 1, 2006.

(51) Int. Cl. G11B 5/52

(52) U.S. Cl. 360/86

(57) ABSTRACT

A Pre-Contact Signal Detector (PCSD) used to predict contact between read-write head and disk surface. A preamplifier may include the PCSD. A main flex circuit may include the preamplifier. A head stack assembly may include the main flex circuit. An embedded circuit may use a pre-contact alert circuit, which may also be included in the PCSD and/or the preamplifier, also the main flex circuit, the head stack assembly. A hard disk drive may include the head stack assembly communicating with the embedded circuit. Manufacturing methods for these and their products of the manufacturing processes, including the program system.

### CROSS-REFERENCE TO RELATED APPLICATIONS

This application claims priority to U.S. Provisional Application No. 60/841,857, filed on Sep. 1, 2006, which is incorporated herein by reference.

### TECHNICAL FIELD

This relates to hard disk drives, in particular to the apparatus interfacing the read-write head with embedded control circuitry and methods of analyzing and responding to data generated by such apparatus.

### BACKGROUND OF THE INVENTION

Today's hard disk drive typically includes a disk pack, which in turn includes a disk clamp coupling at least one disk to a spindle motor. The hard disk drive includes a head stack assembly pivoting through an actuator pivot to position one or more read-write heads, embedded in sliders, each over a rotating disk surface of one of the disks being rotated by the spindle motor. The data stored on the disk surface is typically arranged in concentric tracks. To access the data of a track, a read-write head is positioned by electrically stimulating the voice coil motor, which couples through the voice coil and an actuator arm to move a head gimbal assembly in positioning the slider close to the track.

The slider of today's hard disk drives flies a very short distance off the rotating disk surface, often within 10 nanometers. This is small enough that it is extremely easy for the read-write head to contact the rotating disk surface and simultaneously, very difficult to measure the flying height and/or predict when contact is imminent. Apparatus for detecting when contact is imminent and/or methods responding to such detections are needed to improve the reliability of hard disk drives.

### SUMMARY OF THE INVENTION

Embodiments of the invention include a pre-contact signal detector extracting a pre-contact detection signal experimentally found present in the read signal from a read head just before the read-write head makes contact with the rotating disk surface it is accessing in a hard disk drive. Using this signal to predict contact allows the embedded circuit directing the hard disk drive to respond by asserting one or more vertical actuator control signals to direct the slider to alter its vertical position, lifting it further away from the disk surface. The extracted signal may also be used to calibrate the write parameters for a given track zone at a given temperature range. The write parameters may further be chosen based upon a humidity range.

The pre-contact signal detector predicts contact before it occurs, and consequently, aids in avoiding damage to the disk surface from such contacts. The pre-contact detection signal may be used to create a pre-contact condition recognized by a pre-contact alert circuitry as active shortly before the read-write head contacts the disk surface. The pre-contact detection signal may create a pre-contact condition presented to and recognized by the pre-contact alert circuit. The pre-contact alert circuit may include any combination of a computer responding to the pre-contact condition as directed by a program system to execute program steps residing in an accessibly coupled memory, a finite state machine, a neural network, and/or an inference engine.

A preamplifier used in the main flex circuit may preferably include the pre-contact signal detector, placing it close to the read head making it more sensitive and less prone to transmission noise. The preamplifier may further include the pre-contact alert circuit, rather than in the embedded circuit. Embodiments include manufacturing methods for the preamplifier and the preamplifier as a product of these processes.

A main flex circuit may preferably include the pre-contact signal detector, which may further be preferably included the above mentioned preamplifier. The main flex circuit may further include the pre-contact alert circuit. The main flex circuit may further include a vertical driver stimulated at least in part by the pre-contact alert circuit to alter the flying height of the slider. Embodiments may include a head stack assembly preferably including the main flex circuit coupling to the read-write head of the slider, providing a read signal to the pre-contact signal detector of the preamplifier to create the extracted signal. Embodiments include manufacturing methods for the main flex circuit and the head stack assembly, and these products of the manufacturing processes.

An embedded circuit may include the pre-contact alert circuit. The computer may be responsible for the positioning of the slider to follow a track on the disk surface, a function traditionally referred to as the servo-computer and/or the computer may be responsible for encoding and decoding data for accessing the track, a function traditionally referred to as the embedded computer. A program system may reside in a volatile and/or preferably in a non-volatile memory component of the accessibly coupled memory. As used herein, a computer includes at least one data processor and at least one instruction processor, where each data processor is directed by at least one instruction processor. The embedded circuit may preferably be implemented on a system on an integrated circuit, which may or may not include the non-volatile memory component. The embedded circuit may further include a printed circuit board with a coupling to the head stack assembly to receive the pre-contact detection signal. Embodiments include manufacturing methods for the program system residing in the non-volatile memory component, the system on an integrated circuit and the printed circuit board, as well as these items as product of these manufacturing processes.

A hard disk drive may include the above disclosed head stack assembly coupling with the embedded circuit. A method of calibrating an assembled embodiment of the hard disk drive to configure the pre-contact signal detector, to create the hard disk drive, as well as the hard disk drive as a product of this process. Also, a method of calibrating the pre-contact signal detector together with the preamplifier in the assembled hard disk drive to further create the hard disk drive, as well as the hard disk drive as a product of this process. Calibrating may include optimizing an overshoot amplitude, an overshoot duration, and a write current for a specific track zone and a specific temperature range. The method may further include optimizing for a specific humidity range and/or optimizing an overshoot slope.

### BRIEF DESCRIPTION OF THE DRAWINGS

FIG. 1A shows an example of a hard disk drive in accord with the invention including the pre-contact signal detector in the main flex circuit and the pre-contact alert circuit in the embedded circuit, where the main flex circuit is included in a head stack assembly, the head stack assembly, with the head stack assembly coupled with the embedded circuit providing the threshold detect to the pre-contact alert circuit, which in turn influences the vertical driver to generate the vertical actuator control signal to alter the vertical position of the read-write head near a rotating disk surface;

FIG. 1B shows a further example of a hard disk drive where the pre-contact signal detector is included in the preamplifier and the pre-contact alert circuit in the embedded circuit;

FIGS. 2A to 4B shows various aspects of the pre-contact signal detector of FIGS. 1A and 1B, which include a pre-contact filter and a pre-contact threshold comparator as well as possibly including a pre-contact threshold generator and/or pre-contact filter controls and/or a low-pass pre-contact filter and/or a band-pass pre-contact filter and/or a pre-contact amplifier and/or a read signal multiplexer;

FIG. 5A shows an example of a hard disk drive with the preamplifier including the pre-contact signal detector and the pre-contact alert circuit of previous Figures, in accord with the invention;

FIG. 5B shows an example of a hard disk drive with the main flex circuit including the pre-contact signal detector, the pre-contact alert circuit and the vertical driver of previous Figures, also in accord with the invention;

FIG. 5C shows an example of the hard disk drive with the preamplifier including the pre-contact signal detector, the pre-contact alert circuit and the vertical driver of previous Figures, also in accord with the invention;

FIGS. 6A to 6D show various components which may be included in the pre-contact alert circuit of FIGS. 1A, 1B and 5A to 5C, which may include a computer accessibly coupled to a memory via a buss and directed by a program system and/or a finite state machine and/or a neural network and/or an inference engine;

FIG. 6E shows an example of an alternative of the pre-contact alert circuit as used in FIGS. 5B and 5C, where the pre-contact alert circuit receives the threshold detect and generates the vertical position control state;

FIG. 6F shows a detail of the program system of FIG. 6A and/or 6E;

FIG. 7A shows additional details of the hard disk drive of FIGS. 1A, 1B, 5A to 5B including the lateral positioning of the read-write head near a track on the rotating disk surface by the voice coil motor, which includes the interaction of the voice coil with fixed magnets, which cause the head stack assembly to pivot through the actuator pivot moving the actuator arm and had gimbal assembly;

FIG. 7B shows some details of a head gimbal assembly including a micro-actuator assembly employing a piezoelectric effect and coupling to the slider;

FIG. 8A shows the memory of FIG. 6A with volatile and non-volatile memory components housing the program system;

FIG. 8B shows some details of calibrating the preamplifier shown in FIG. 6F;

FIG. 9 shows an exploded view of the primary assembly components of the hard disk drive, in particular, the hard disk drive may include only one disk but at least two disks as shown here, the spindle motor couples to the disks through the spindle shaft, and are separated by disk spacers, with the disk pack being held together by a disk clamp and mounted on the disk base;

FIG. 10 shows the hard disk drive and the embedded circuit with temperature and humidity sensors, controlling the position of the read-write head particularly in track following mode by using a position error signal to access the track;

FIGS. 11A and 11B show a micro-actuator assembly employing an electrostatic effect, including a first electrostatic micro-actuator and a second electrostatic micro-actuator;

FIG. 12A shows an alternative method of calibrating the hard disk drive as a variation of the program system of previous Figures through selecting a center frequency for the pre-contact band-pass filter and/or selecting the pre-contact threshold for the pre-contact threshold comparator and/or verifying a flying height power curve for a vertical position control state and/or determining the pre-contact threshold to warn of impending contact; and

FIGS. 12B to 14 show graphs that facilitate the understanding of FIG. 12A.

### DETAILED DESCRIPTION

This application relates to hard disk drives, in particular to the interfacing apparatus with the read-write head and methods of analyzing and responding to data resulting from such interfaces.

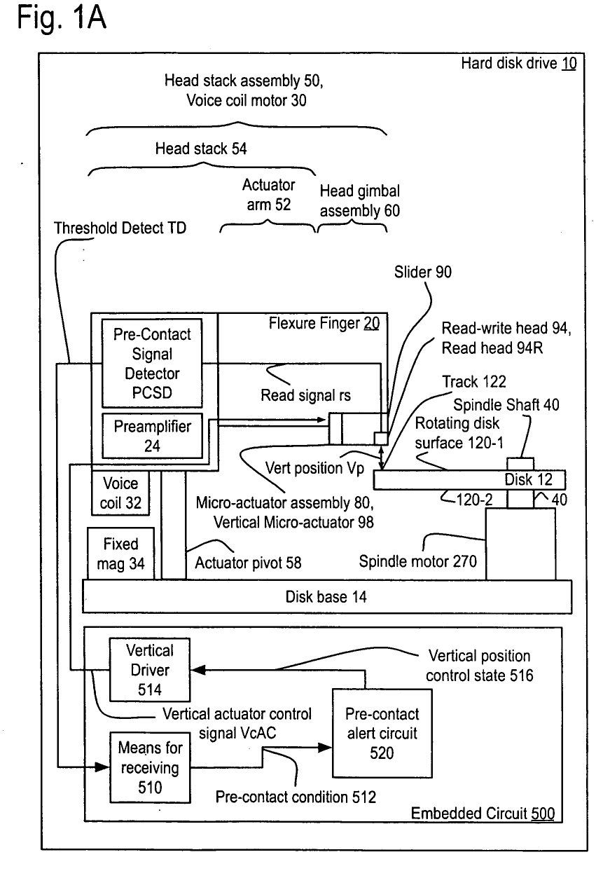

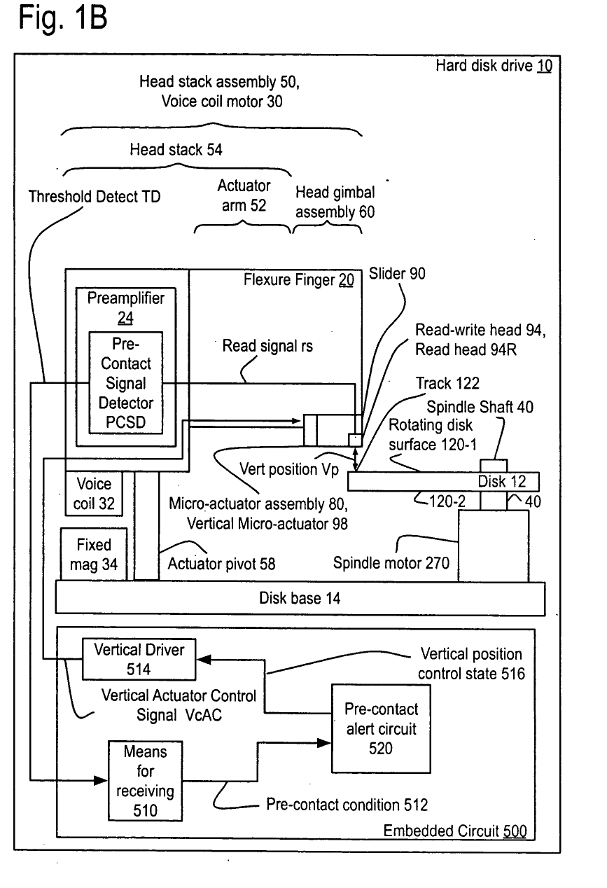

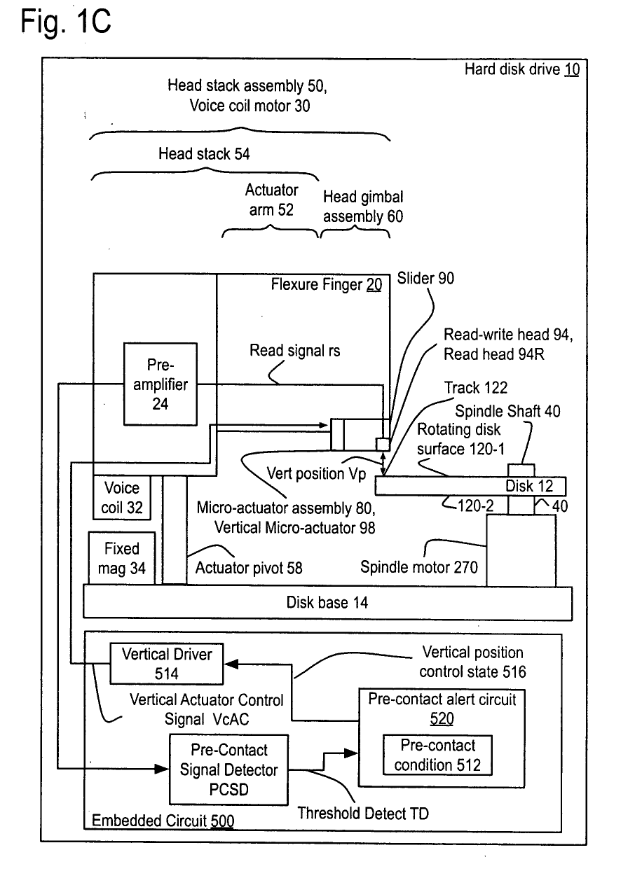

Embodiments include a pre-contact signal detector PCSD detecting a signal possessing a frequency band component that can be detected from the read signal rs of the read head 94R, which were found in experiments to be present just before the read-write head makes contact with the rotating disk surface 120-1 it is accessing in a hard disk drive 10, as shown in FIG. 1A and 1B. Using this extracted signal, known herein as the pre-contact detection signal TD to predict contact allows the embedded circuit 500 directing the hard disk drive to respond by altering at least one vertical actuator control signal VcAC to direct the slider 90 to alter its vertical position Vp, in particular, the vertical position of the read-write head 94 lifting it further away from the disk surface.

Experiments by the inventors showed that just prior to contact between the read-write head 94 and the disk surface 120-1, the head stack assembly 50 causes the slider 90 to develop a vibration that modulates the flying height, also known herein as the vertical position VP, and causes the read head 94-R output, known herein as the read signal rs, to develop a frequency band component on top of the expected read head output. The read head used in the experiments was a tunneling magneto-resistive head. The observed frequency band component was between 100 and 400 kiloherz (KHz). The inventors recognized that detecting this signal would allow predicting contact between the slider and the disk surface, and allow adjustment of the flying height to avoid that contact, thereby improving the reliability of the hard disk drive 10.

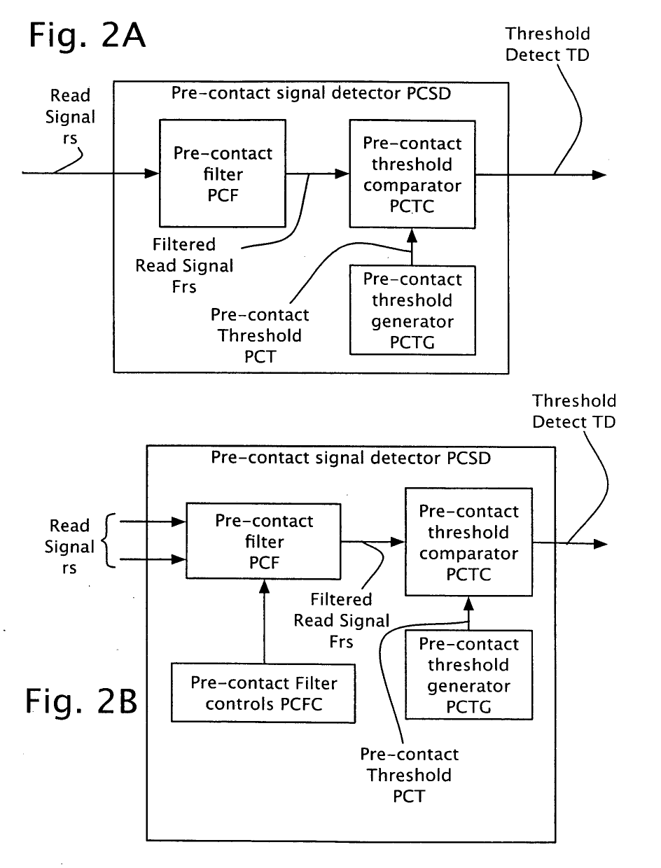

The pre-contact signal detector PCSD may include a read signal RS received from a read head 94R as shown in FIGS. 1A and 1B, and filtered by a pre-contact filter PCF to provide a filtered read signal Frs to a pre-contact threshold comparator PCTC for comparison with a pre-contact threshold PCT to create the pre-contact detection signal TD, where the pre-contact detection signal is active shortly before a read-write head 94 containing the read head contacts a rotating disk surface 120-1, as shown in FIGS. 2A to 4B.

The pre-contact signal detector PCSD preferably further includes a pre-contact threshold generator PCTG, which generates the pre-contact threshold PCT, as shown in FIGS. 2A to 4B. The read signal rs may include a differential signal pair based upon a differential signal pair responding to the read head 94R, as shown in FIGS. 2B to 4A.

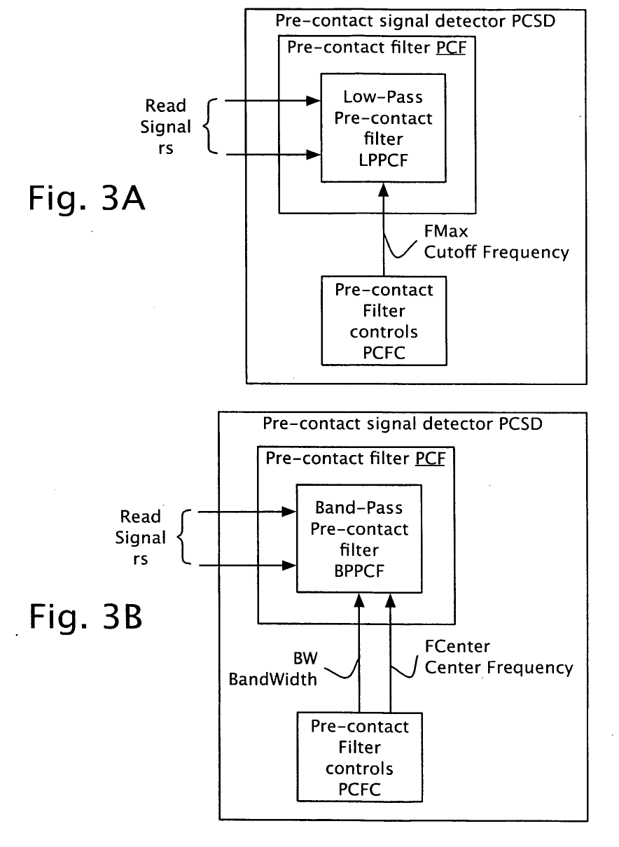

The pre-contact signal detector PCSD may include a pre-contact filter control generator PCFC as shown in FIGS. 2B to 3B. FIG. 3A shows an example pre-contact filter PCF including a low pass pre-contact filter LPPCF controlled by a cutoff frequency FMax generated by the pre-contact filter control generator. FIG. 3B shows another example pre-contact filter PCF including a band-pass pre-contact filter BPPCF which is controlled by a center frequency FCenter, and preferably, also controlled by a bandwidth BW, both generated by the pre-contact filter control generator.

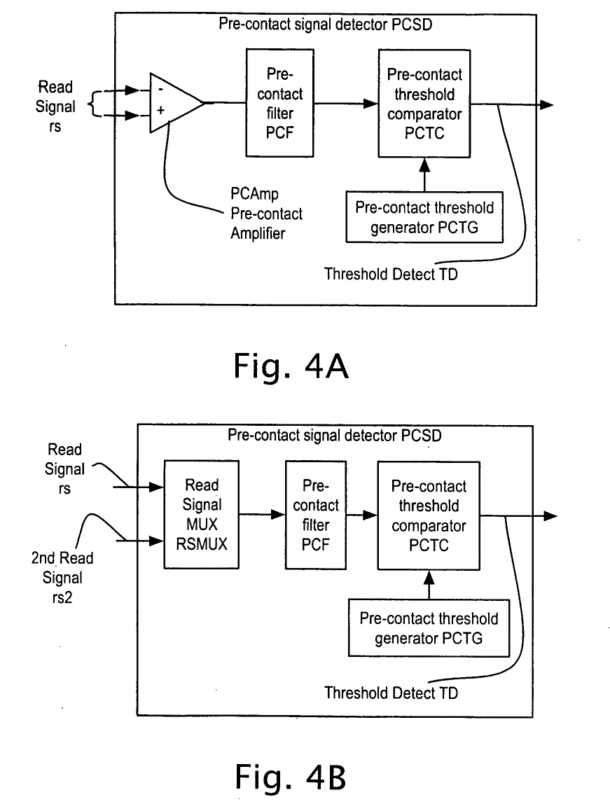

The read signal rs may be amplified before being used by the pre-contact filter PCF, as shown in the example of FIG. 4A by the pre-contact amplifier PCPAmp receiving the read signal before its use by the pre-contact filter. More than one read signal may be selected for use by the pre-contact filter, as shown by the example in FIG. 4B, where the read signal multiplexer RSMUX selects one of the read signal and a second read signal rs2 for use by the pre-contact filter.

The pre-contact signal detector may be manufactured by providing the pre-contact filter and the pre-contact threshold comparator to create the pre-contact signal detector as a product of this manufacturing process. By way of example, providing the pre-contact filter and the pre-contact threshold comparator may preferably be done using a semiconductor manufacturing process by repeated deposition, etching, doping of various layers of metals and other chemical to create transistors, capacitors, resistors and wiring them together to create the pre-contact signal detector.

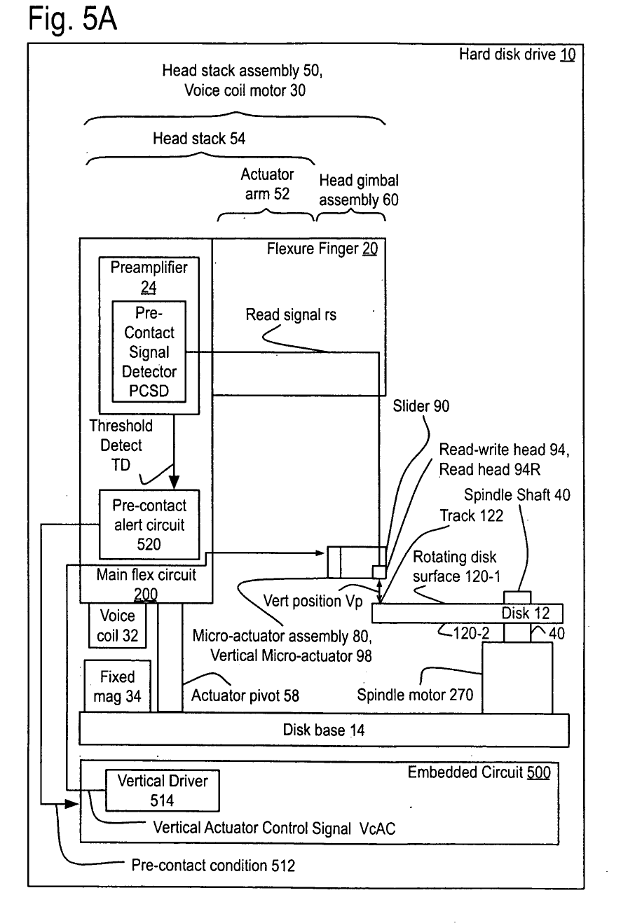

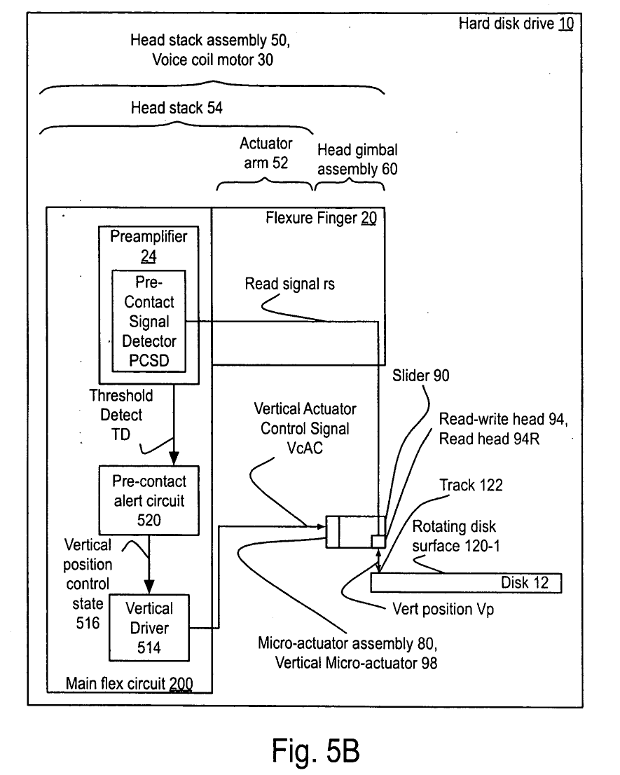

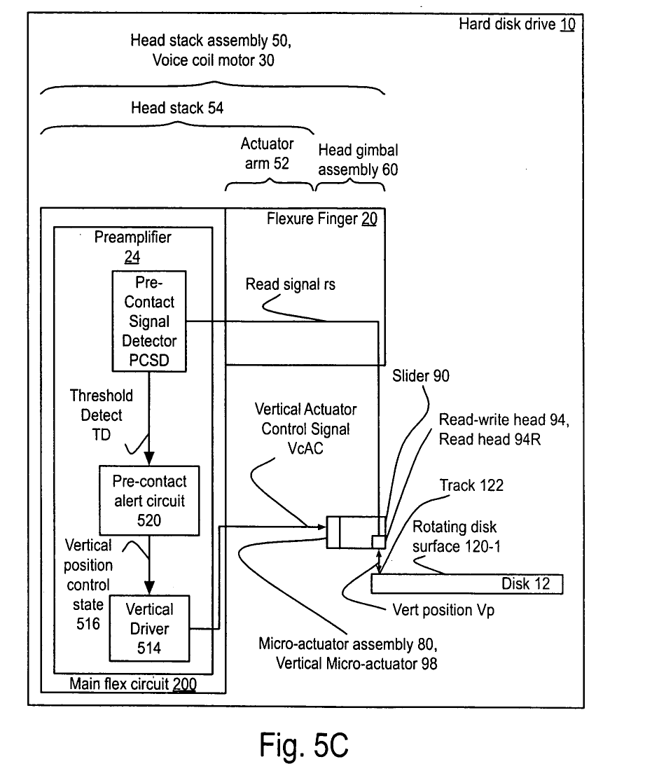

The pre-contact signal detector PCSD, may be preferably included in the preamplifier 24, generating the pre-contact detection signal, as shown in FIGS. 1B and 5. The preamplifier may be manufactured by providing the pre-contact signal detector to create the preamplifier as a product of this manufacturing process. This may further include providing the pre-contact filter and the pre-contact threshold comparator to create the pre-contact signal detector. And again, by way of example, providing the pre-contact filter and the pre-contact threshold comparator may preferably be done using a semiconductor manufacturing process by repeated deposition, etching, doping of various layers of metals and other chemical to create transistors, capacitors, resistors and wiring them together to create the pre-contact signal detector.

Embodiments further include apparatus in the embedded controller 500 receiving the pre-contact detection signal to create a pre-contact condition 512 recognized by the invention's pre-contact alert circuitry 520. This apparatus has the advantage of predicting contact between the read-write head and the disk surface before it occurs, and consequently, avoiding the potential for damage to the disk surface from that contact. It also has the advantage of placing the pre-contact signal detector close to the read head 94R in the preamplifier, rather than in the embedded circuit, which makes it more sensitive and less prone to transmission noise.

A main flex circuit 200 preferably includes this preamplifier, and the head stack assembly 50 preferably includes this main flex circuit coupling through a flexure finger 20 to the read-write head 94 of the slider 90, providing a read signal rs to the pre-contact signal detector of the preamplifier to create the pre-contact detection signal TD, as shown in FIG. 5. Embodiments include manufacturing methods for the preamplifier, the main flex circuit, and the head stack assembly, and these items as products of these manufacturing processes.

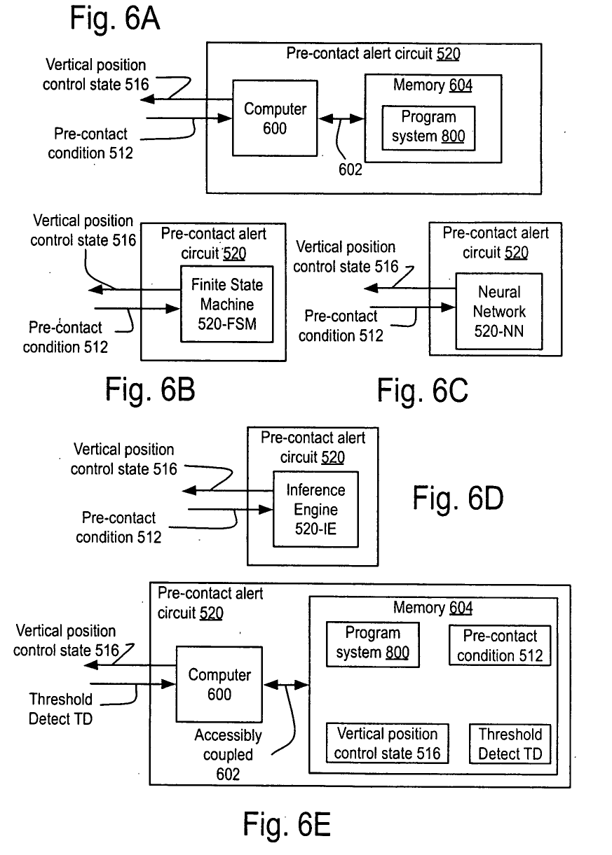

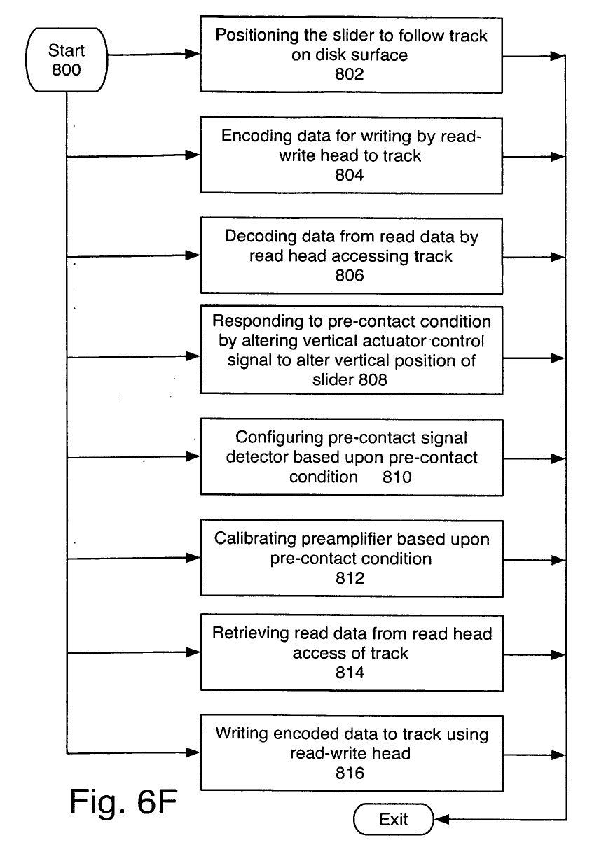

The embedded circuit 500 may include means for receiving 510 the pre-contact detection signal TD to create a pre-contact condition 512 presented to and recognized by a pre-contact alert circuit 520 as shown in FIGS. 1 and 5. The pre-contact alert circuit may include any combination of a computer 600 responding to the pre-contact condition 512 as directed by a program system 800 to execute program steps residing in an accessibly coupled 602 memory 604 as shown in FIG. 6A, a finite state machine 520-FSM as shown in FIG. 6B, a neural network 520-NN as shown in FIG. 6C, and/or an inference engine 520-IE as shown in FIG. 6D. An instance of the finite state machine may include at least one instance of at least one of the following: a programmable logic array, a programmable logic cell, the non-volatile memory component, the volatile memory component, a logic gate, and a programmable routing block coupling to at least one of these instances. The neural network may include at least two neurons communicatively coupled by at least one synaptic connection. The inference engine includes at least one fact, and at least one inference rule responding to at least one of the facts to respond to the pre-contact condition. FIG. 6E shows the pre-contact alert circuit further including the memory containing a version of the threshold detect TD, as well the pre-contact condition 512.

By way of example, an instance of the computer 600 may preferably any combination of the program steps of the program system 800 as shown in FIG. 6F, which includes the following. Operation 802 supports positioning of the slider 90 to follow a track 122 on the disk surface 120-1, a function traditionally referred to as the servo-computer. Operation 804 supports encoding data to create the encoded data for writing by the read-write head to the track. Operation 806 supports decoding the read data from the read-head access of the track. Often, operations 804 and 806 are considered a function traditionally referred to as the embedded computer. Operation 808 supports responding to the pre-contact condition 512 by altering a vertical actuator control signal VcAC sent to a vertical micro-actuator causing the slider 90 to alter the vertical position VP of the slider, in particular the read-write head 94, over the disk surface 120-1. The vertical micro-actuator may include an vertical micro-actuator 98 embedded in the slider, and/or be part of a micro-actuator assembly 80 coupled to the slider. Operation 810 supports configuring the pre-contact signal detector PCSD based upon the pre-contact condition. Operation 812 supports calibrating the preamplifier 24 based upon the pre-contact condition. Operation 814 supports retrieving the read data from the read head access of the track. Operation 816 support writing the encoded data to the track using the read-write head.

Note that in some embodiments, operation 808 may be used in conjunction with operation 802 to follow the track and insure the flying height, or vertical position VP of the slider 90 over the disk surface 120-1 while following the track 122. Writing and reading the track are both performed while the track is being followed and while essential operations, are considered the primary tasks performed while following the track. The encoding the data as shown by operation 804 does not necessarily occur while following the track, and is often completed before the read-write head 94 is close enough to the track for it to be followed. Similarly, the decoding of the read data as shown by operation 806 may often begin after the reading of the track is completed, and does not require that the track continue to be followed.

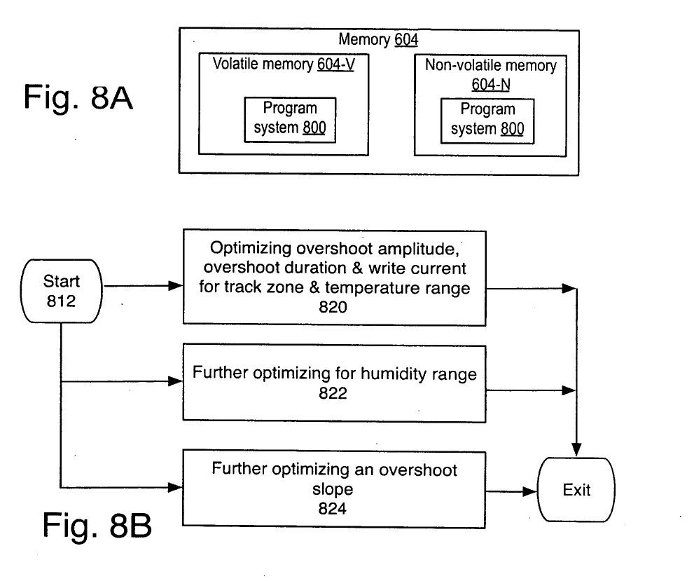

The program system 800 may reside in a volatile memory component 604-V and/or preferably in a non-volatile memory component 604-NV of the memory 604, as shown in FIG. 8A. As used herein, the computer 600 includes at least one data processor and at least one instruction processor, where each data processor is directed by at least one instruction processor.

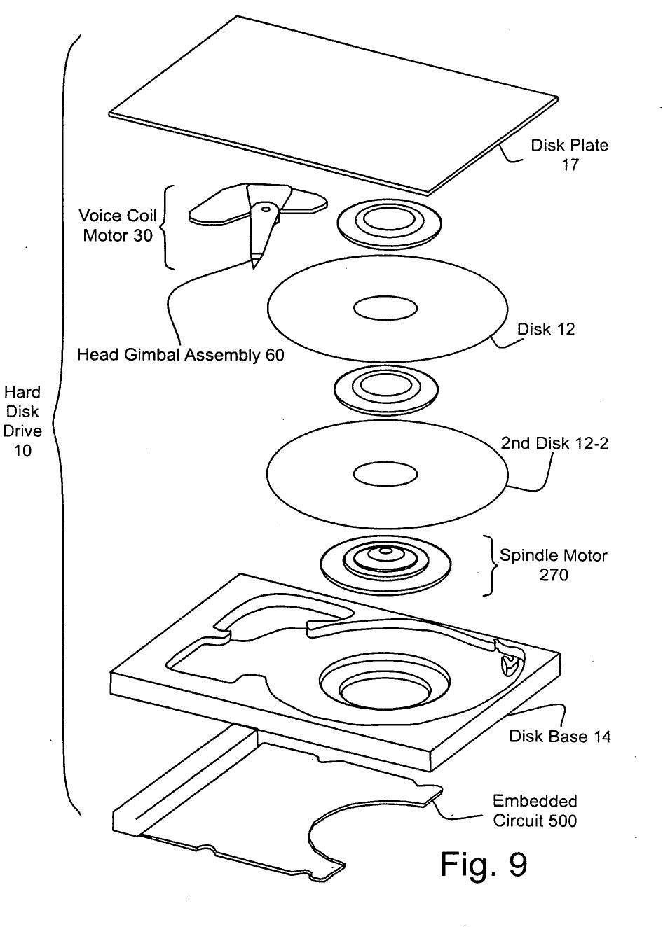

The apparatus in the embedded circuit 500 may preferably be implemented on a system on an integrated circuit, which may or may not include the non-volatile memory component 604-NV. The embedded circuit may further include a printed circuit board as shown in FIG. 9 with a coupling to the head stack assembly 50 to receive the pre-contact detection signal TD, as shown in FIGS. 1A to 1C, 5A to 5C, and 10. Embodiments include manufacturing methods for the program system 800 residing in the non-volatile memory component 604-N, the embedded circuit as a system on an integrated circuit and the printed circuit board, as well as these items as product of these manufacturing processes.

A hard disk drive 10 may preferably includes the head stack assembly 50 coupling with the embedded circuit 500 to provide the pre-contact detection signal TD to the means for receiving 510.

Embodiments also include a method of calibrating an assembled embodiment of the invention's hard disk drive 10 to configure the pre-contact signal detector PCSD as discussed with operation 810 of FIG. 6F, to create the hard disk drive, as well as the hard disk drive as a product of this process.

The method of calibrating the preamplifier 24 as discussed with operation 812 may further include optimizing an overshoot amplitude, an overshoot duration, and a write current for a specific track zone and a specific temperature range, which is shown as operation 820 in FIG. 3B. The method may further include optimizing for a specific humidity range as shown in operation 822 and/or further optimizing an overshoot slope. This method also uses an assembled hard disk drive to create the hard disk drive 10, which has optimized write parameters for a track zone. As used herein, the disk surface 120-1 is preferably partitioned into a collection of mutually exclusive track zone, each including a radial succession of multiple, adjacent tracks.

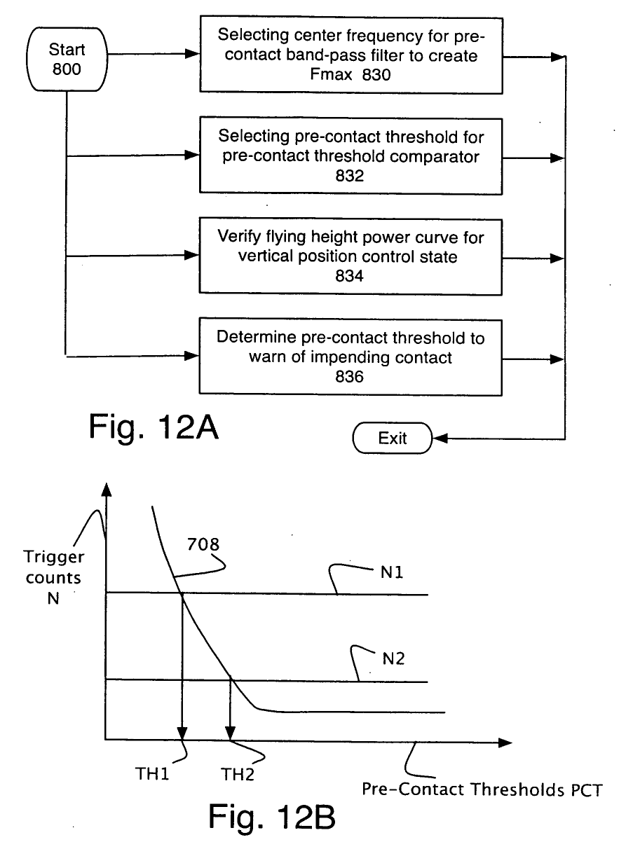

In certain preferred embodiments, the pre-contact signal detector PCSD includes the components of FIGS. 2B and 3B. One preferred method of calibration for a hard disk drive 10 including this embodiment can be summarized as a variation on the operations of FIGS. 6F, as shown in FIG. 12A.

Operation 830 supports selecting the center frequency FCenter and bandwidth BW for the pre-contact band-pass filter PCBPF of FIG. 3B, which is done so that the selected frequency Fmax yields the maximum Root Mean Square (RMS) output of the filter.

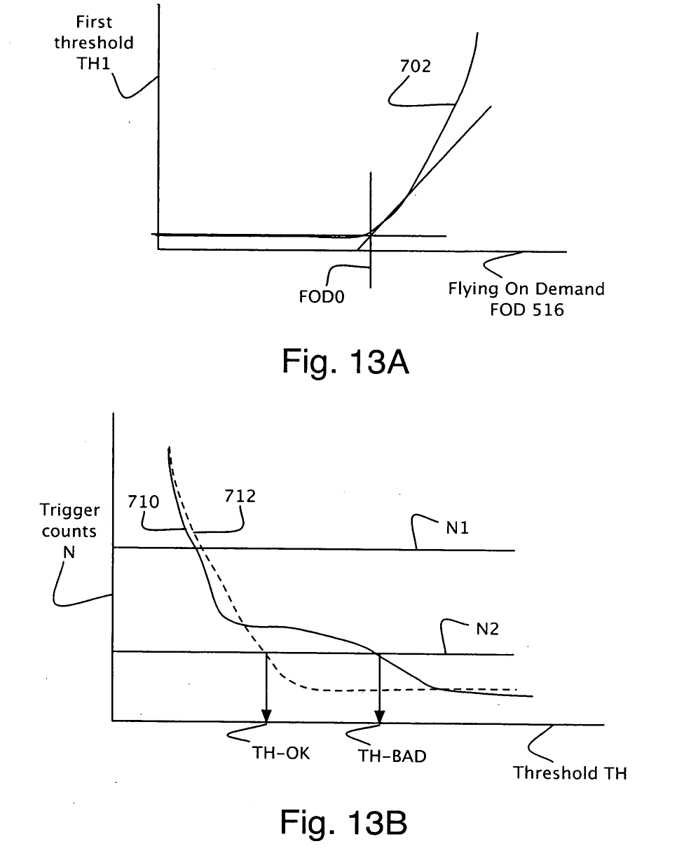

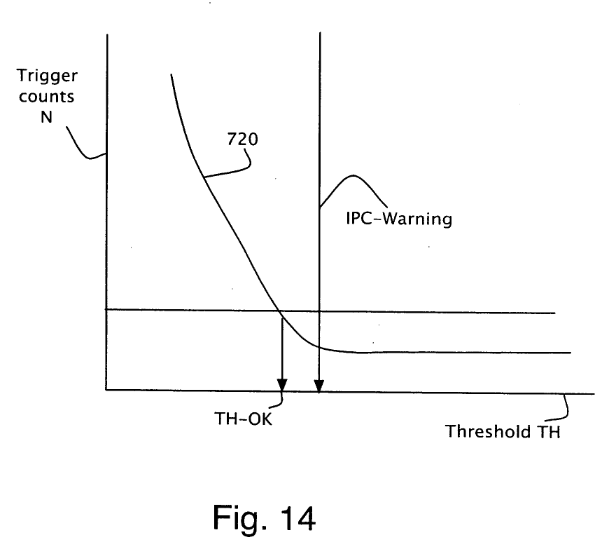

Operation 832 supports selecting the pre-contact threshold PCT for the pre-contact threshold comparator PCTC, by first setting the pre-contact band-pass filter PCBPF to the minimum bandwidth BW and the selected frequency Fmax having the maximum RMS filter output. Starting from a maximum or minimum value of the range of the vertical position control state, the range of the pre-contact threshold is examined to count the number of triggering events in a prescribed amount of time at that threshold and vertical control position state as trace 708, leading to a succession of trigger counts N forming the vertical axis versus pre-contact thresholds PCT forming the horizontal axis as shown in FIG. 12B. N1 represents the count threshold for average read-write Head to disk Media (H/M) pre-contact monitoring and N2 represents the count threshold for H/M instantaneous pre-contact monitoring. These are used to determine the first threshold TH1 and the second threshold TH2, which will be used as the pre-contact threshold settings for average H/M pre-contact monitoring and for instantaneous H/M pre-contact monitoring, respectively. Incrementally perform this ranging across the vertical position control state range, and plot the first threshold TH1, which is the average H/M contact threshold as shown in FIG. 13A. The default vertical position control FOD0 is the intersection of the tangent after the trace 702 leaves the horizontal. Note that the vertical axis represents the first threshold TH1 and the horizontal axis represents what is sometimes known as the Flying On Demand (FOD), or vertical position control state 516.

To confirm these settings, operation 834 supports verifying the flying height power curve as shown in FIG. 13B for the default vertical position control FOD0. This graph shows the contact count N as the vertical axis and the vertical position control threshold is represented as the horizontal axis TH. The trace 712 shows a successful default vertical position control, which crosses the trigger count N2 at the pre-contact threshold represented by TH-OK. The trace 710 shows an unsuccessful default vertical position control, which crosses the trigger count N2 at an unacceptable pre-contact threshold represented by TH-BAD. If the hard disk drive 10 has performed as illustrated by trace 712, then operation 836 may be performed, otherwise, the default vertical position control is altered and this operation is performed again. If the default vertical position control cannot meet the criteria, then the hard disk drive may have a problem with accessing the disk surface 120-1.

Operation 836 supports determining the pre-contact threshold PCT to warn of impending contact between the read-write head 94 and the disk surface 120-1. The acceptable threshold of TH-OK of operation 834 and FIG. 13B is used to establish the Immediate Pre-Contact Warning (IPC-Warning) value. The IPC-Warning value is used for the pre-contact threshold in normal operations, which will lead to triggering the pre-contact detection signal TD, which in turn triggers the pre-contact condition 512, which activates the pre-contact alert circuit 520 to alter the vertical position control state 516 stimulating the vertical driver 514 to change the vertical actuator control signal VcAC. The vertical actuator control signal is sent to the vertical micro-actuator 98 embedded in the slider 90 and/or to the micro-actuator assembly 80 to alter the vertical position Vp of the slider away from the rotating disk surface to avoid contact between the read-write head and the disk surface.

Manufacturing the hard disk drive preferably includes mounting the head stack assembly through its actuator pivot to the disk base to create the hard disk drive. The hard disk drive is a product of this manufacturing process.

As used herein, a head stack includes at least one actuator arm. The head stack may include more than one of these actuator arms, and preferably only these actuator arms. The head stack 54 includes at least one of the actuators coupled to a voice coil 32, as shown in FIGS. 1, 5, 7A, and 10. The head stack may include exactly one actuator arm, or it may include more than one actuator arm.

The head stack assembly 50, includes the head stack 54 coupled to at least one head gimbal assembly 60, further coupling the actuator arm 52 to at least one head gimbal assembly, for each of the actuator arms included in the head stack. At least one actuator arm may couple to two head gimbal assemblies.

The head gimbal assembly 60 may preferably include the slider 90 coupled through a flexure finger 20 to a load beam 30, which couples through a hinge 70 to a base plate 72. The slider includes the read-write head 94, which is embedded in it, forming an air-bearing surface for flying a few nanometers off the disk surface 120-1 during normal access operations of a track 122, which is usually arranged as a concentric circle on the disk surface in the hard disk drive 10 as shown in FIG. 4A. The head gimbal assembly may further include a micro-actuator assembly 80 coupling to the slider to aid in the lateral positioning LP of the read-write head in accessing the track. Since the slider may further include a vertical micro-actuator, which is used to provide some control of the vertical position of the slider above the disk surface. Since the vertical micro-actuator is not directly related to the actuator arms, it is not shown in these Figures. The micro-actuator assembly and/or the vertical micro-actuator may employ a thermal-mechanical effect and/or a piezoelectric effect and/or an electrostatic effect.

The hard disk drive 10 includes the head stack assembly 50 mounted through its actuator pivot 58 to a disk base 14. The hard disk drive preferably includes a voice coil motor 30, which further includes the head stack assembly mounted via its actuator pivot to the disk base with the voice coil 32 positioned to move under/between the fixed magnet 34 in response to a voice coil control signal driven by the embedded circuit 500. The head stack assembly is also positioned so that at least one actuator arm 52 can move at least one head gimbal assembly 60 near a disk surface 120-1 as shown in FIGS. 3 and 4A.

A disk surface 120-1 rotates about a spindle 40 to create the rotating disk surface 120-1. The head stack assembly 50 pivots about the actuator pivot 58. The head stack assembly includes the actuator arm 52 coupled with the voice coil 32. When the voice coil is electrically stimulated with a time-varying electrical signal, it inductively interacts with a fixed magnet 34 attached to the voice coil yoke, causing the actuator arm to pivot by lever action through the actuator pivot. Typically, the fixed magnet is composed of two parts, one attached to the voice coil yoke and the other attached to the bottom voice coil yoke. As the actuator arm pivots, the head gimbal assembly 60 is moved across the disk surface 120-1. This provides the coarse positioning of the slider 90, and consequently, the read-write head 100 over a specific track.

FIG. 9 shows an exploded view of the primary components of the hard disk drive 10 including the voice coil motor 30. The hard disk drive further includes a disk base 14 to which the head stack assembly 50 is preferably mounted. The spindle motor 270 preferably drives the disk 12, and consequently the disk surface 120-1 through the spindle 40. The hard disk drive may further include a second rotating disk surface, to which a second actuator arm 52-2 may position a second head gimbal assembly 60-2. An embedded printed circuit board is used to control the positioning of the read-write head 100, possibly by also using a micro-actuator assembly, as well as the coarse positioning through the interactions with the voice coil 32, the fixed magnet 34 and the actuator arm 52 of the head stack assembly 50.

The read head 94-R may use a spin valve to drive the read differential signal pair. As used herein, the spin valve employs a magneto-resistive effect to modulate a sensing voltage, or alternatively, a sensing current, which is conducted from one lead, through the magneto-resistive element to the other lead. The magneto-resistive element is located between the first shield and the second shield.

The read head 94-R may use a tunnel valve to drive the read differential signal pair. As used herein, a tunnel valve uses a tunneling effect to modulate the sensing current perpendicular to the first shield and the second shield. Both longitudinally recorded signals and perpendicularly recorded signals can be read by either reader type. Perpendicular versus longitudinal recording relates to the technology of the writer/media pair, not just the reader.

The tunnel valve is used as follows. A pinned magnetic layer is separated from a free ferromagnetic layer by an insulator, and is coupled to a pinning antiferromagnetic layer. The magneto-resistance of the tunnel valve is caused by a change in the tunneling probability, which depends upon the relative magnetic orientation of the two ferromagnetic layers. The sensing current Is, is the result of this tunneling probability. The response of the free ferromagnetic layer to the magnetic field of the bit of the track 122 of the disk surface 120-1, results in a change of electrical resistance through the tunnel valve.

The flexure finger 20 for the slider 90, preferably contains a micro-actuator assembly 80 for mechanically coupling to the slider to aid in positioning the slider to access the data 122 on 120-1 disk surface of the disk 12. The micro-actuator assembly may aid in laterally positioning LP the slider to the disk surface as shown in and/or aid in vertically positioning VP the slider. The flexure finger 20 may further provide the vertical control signal VcAC and preferably the first lateral control signal as the first slider power terminal to the vertical micro-actuator.

The flexure finger 20 preferably includes the lateral control signal 82 and trace paths between the slider for the write differential signal pair. The lateral control signal preferably includes the first lateral control signal and the second lateral control signal, as well as the AC lateral control signal. When the slider does not contain an amplifier 96, the flexure finger further preferably provides trace paths for the read differential signal pair.

The micro-actuator assembly 80 may employ a piezoelectric effect and/or an electrostatic effect to aid in positioning the slider 90. First, examples of micro-actuator assemblies employing the piezoelectric effect will be discussed followed by electrostatic effect examples. The micro-actuator assembly may preferably couple with the head gimbal assembly 60 through the flexure finger 20, as shown in FIG. 5B. The micro-actuator assembly may further couple through the flexure finger to a load beam 74 to the head gimbal assembly and consequently to the head stack assembly 50.

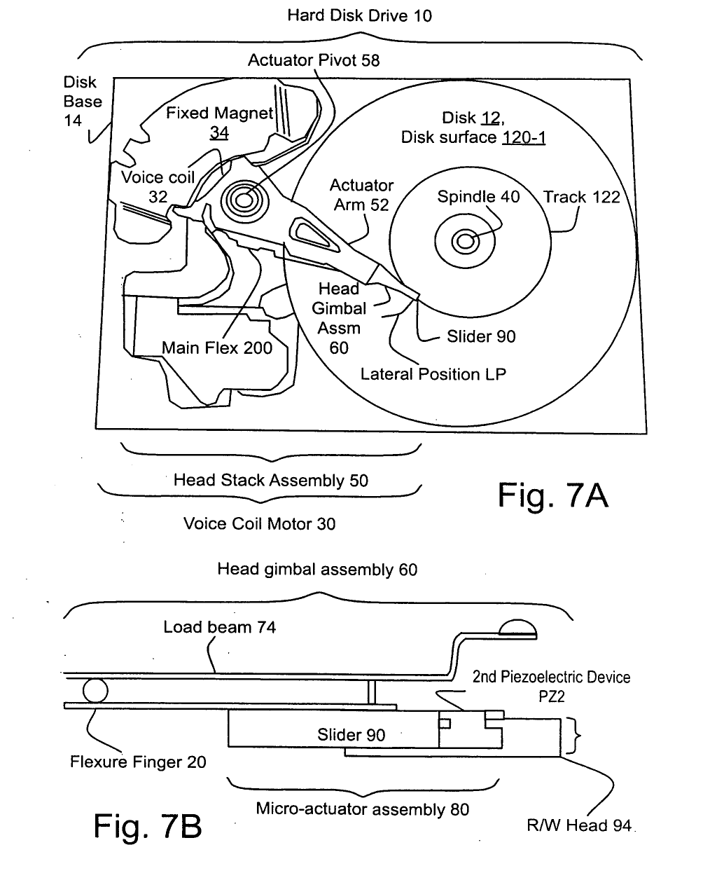

Examples of micro-actuator assemblies employing the piezoelectric effect are shown in FIG. 7B, which shows a side view of a head gimbal assembly with a micro-actuator assembly 80 including at least one piezoelectric element for aiding in laterally positioning LP of the slider 90, as shown in FIG. 7A. In certain embodiments, the micro-actuator assembly may consist of one piezoelectric element. The micro-actuator assembly may include the first piezoelectric element and a second piezoelectric element, both of which may preferably aid in laterally positioning the slider. In certain embodiments, the micro-actuator assembly may be coupled with the slider with a third piezoelectric element to aid in altering the vertical position Vp the slider above the disk surface 120-1.

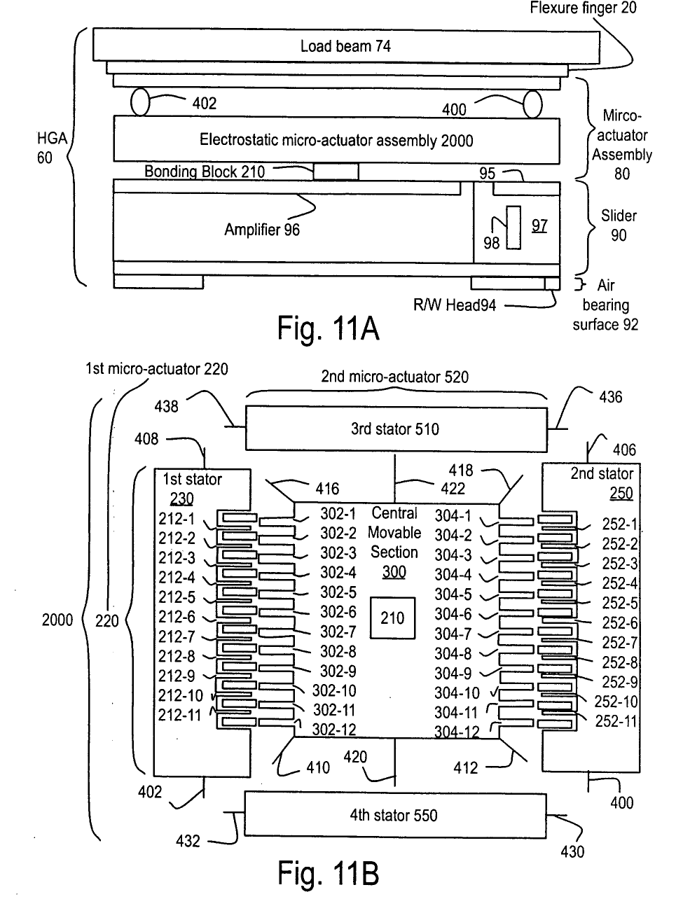

Examples of the micro-actuator assemblies employing the electrostatic effect are shown in FIGS. 11A and 11B derived from the Figures of U.S. patent application Ser. No. 10/986,345, which is incorporated herein by reference. FIG. 11A shows a schematic side view of the micro-actuator assembly 80 coupling to the flexure finger 20 via a micro-actuator mounting plate 700. FIG. 1B shows the micro-actuator assembly using an electrostatic micro-actuator assembly 2000 including a first electrostatic micro-actuator 220 to aid the laterally positioning LP of the slider 90. The electrostatic micro-actuator assembly may further include a second electrostatic micro-actuator 520 to aid in the vertically positioning VP of the slider.

The first micro-actuator 220 includes the following. A first pivot spring pair 402 and 408 coupling to a first stator 230. A second pivot spring pair 400 and 406 coupling to a second stator 250. A first flexure spring pair 410 and 416, and a second flexure spring pair 412 and 418, coupling to a central movable section 300. A pitch spring pair 420-422 coupling to the central movable section 300. The central movable section 300 includes signal pair paths coupling to the write differential signal pair and either the read differential signal pair or the amplified read signal of the read-write head 94 of the slider 90.

The bonding block 210 may electrically couple the read-write head 90 to the amplified read signal and write differential signal pair, and mechanically couples the central movable section 300 to the slider 90 with read-write head 94 embedded on or near the air bearing surface 92 included in the slider.

The first micro-actuator 220 aids in laterally positioning LP the slider 90, which can be finely controlled to position the read-write head 94 over a small number of tracks 122 on the disk surface 120-1. This lateral motion is a first mechanical degree of freedom, which results from the first stator 230 and the second stator 250 electrostatically interacting with the central movable section 300. The first micro-actuator 220 may act as a lateral comb drive or a transverse comb drive, as is discussed in detail in the incorporated U.S. patent application.

The electrostatic micro-actuator assembly 2000 may further include a second micro-actuator 520 including a third stator 510 and a fourth stator 550. Both the third and the fourth stator electrostatically interact with the central movable section 300. These interactions urge the slider 90 to move in a second mechanical degree of freedom, aiding in the vertically positioning VP to provide flying height control. The second micro-actuator may act as a vertical comb drive or a torsional drive, as is discussed in detail in the incorporated U.S. patent application. The second micro-actuator may also provide motion sensing, which may indicate collision with the disk surface 120-1 being accessed.

The central movable section 300 not only positions the read-write head 10, but may act as the conduit for the write differential signal pair and in certain embodiments, the first slider power signal and the second slider power signal, as well as the read differential signal pair or the amplified read signal. The electrical stimulus of the first micro-actuator 220 is provided through some of its springs.

The central movable section 300 may preferably to be at ground potential, and so does not need wires. The read differential signal pair, the amplified read signal, the write differential signal pair and/or the slider power signals and traces may preferably be routed with flexible traces all the way to the load beam 74 as shown in FIG. 8A.

The flexure finger 20 may further provide a read trace path rtp for the amplified read signal. The slider 90 may further include a first slider power terminal and a second slider power terminal, both electrically coupled to the amplifier 96 to collectively provide power to generate the amplified read signal. The flexure finger may further include a first power path electrically coupled to the first slider power terminal and/or a second power path electrically coupled to the second slider power terminal, which are collectively used to provide electrical power to generate the amplified read signal.

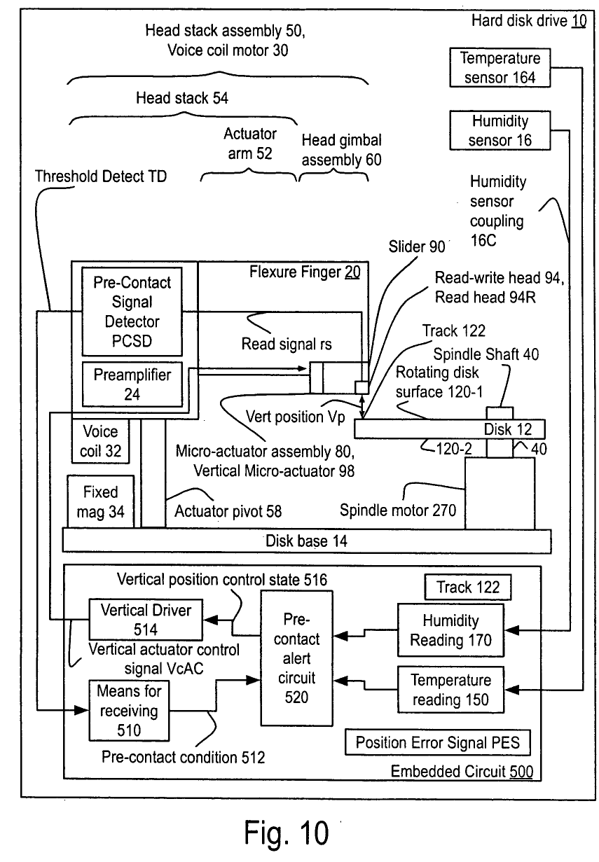

In certain embodiments, the hard disk drive 10 may preferably include the disk base 14 coupled to the disk cover 17 to enclose a humidity sensor 16 and a temperature sensor 164, as shown in FIG. 10. The humidity sensor communicates via a humidity sensor coupling 16C to create a humidity reading 170 which may preferably be used in the embedded circuit 500. The temperature sensor may preferably share the humidity sensor coupling as shown, or it may have a separate sensor coupling, either of which is used to create a temperature reading 150, which is also used in the embedded circuit.

The hard disk drive 10 with the embedded circuit 500 may preferably control the lateral position LP of the read-write head 94 to follow a track 122 on the rotating disk surface 120-1 in what is sometimes called track following mode by using a position error signal PES derived from the read signal rs received by the preamplifier 24. The position error signal is used as a feedback control by the embedded circuit to keep the read-write head close to the track by controlling the voice coil motor 30. A time varying electrical signal is generated by the embedded circuit to stimulate the voice coil 32, which induces a time varying electromagnetic field that interacts with the fixed magnet 34 to apply a time varying force on the head stack assembly 50, in particular to the head stack 54, which is rigidly coupled to the voice coil and moves through the actuator pivot 58, causing the actuator arm 52 and the head gimbal assembly 60 to swing across the rotating disk surface.

It is common that during track following mode the vertical position Vp of the slider 90 must be stably kept flying at the minimum distance off the rotating disk surface 120-1. This is a situation in which accurate prediction of when contact between the slider and the rotating disk surface is quite useful and at least some of the various aspects and embodiments may be operational to determine the threshold detect TD and/or the pre-contact condition 512 and to affect the vertical position control state 516, which in turn drives the vertical actuator control signal VcAC, which is used by the vertical micro-actuator 98 and/or the micro-actuator assembly 80 to alter the vertical position.

The preceding embodiments provide examples of the invention and are not meant to constrain the scope of the following claims.

What is claimed is:

1. A pre-contact signal detector for a hard disk drive, comprising: a pre-contact filter, and a pre-contact threshold comparator, further comprising:
a read signal received from a read head and filtered by said pre-contact filter to provide a filtered read signal to said pre-contact threshold comparator for comparison with a pre-contact threshold to create the pre-contact detection signal;
wherein said pre-contact detection signal is active shortly before a read-write head containing said read head contacts a rotating disk surface.

2. The pre-contact signal detector of claim 1, wherein said pre-contact filter includes at least one member of the group consisting of: a low pass filter with a cut-off frequency; and a band pass filter with a center frequency and a bandwidth.

3. The pre-contact signal detector of claim 2, further comprising: a pre-contact filter control providing at least one member of the group consisting of: said cut-off frequency to said low-pass filter; said center frequency to said band pass filter; and said bandwidth to said band pass filter.

4. The pre-contact signal detector of claim 3, wherein said pre-contact filter control is directed by an embedded circuit in said hard disk drive.

5. The pre-contact signal detector of claim 1, further comprising: a pre-contact threshold generator generating said pre-contact threshold.

6. The pre-contact signal detector of claim 5, wherein said pre-contact threshold generator is directed by an embedded circuit in said hard disk drive.

7. The pre-contact signal detector of claim 1, further comprising: an amplifier receiving said read signal to create an amplified signal presented to said pre-contact filter.

8. A preamplifier for said hard disk drive, comprising: said pre-contact signal detector of claim 1 provided a version of said read signal based upon a read signal coupling to said read head to create said pre-contact detection signal.

9. A main flex circuit, comprising: said pre-contact signal detector of claim 1 provided a version of said read signal based upon a read signal coupling to said read head to create said pre-contact detection signal.

10. The main flex circuit of claim 9, further comprising a preamplifier;
wherein preamplifier, comprises:
said pre-contact signal detector provided said version of said read signal based upon said read signal coupling to said read head to create said pre-contact detection signal.

11. A head stack assembly, comprising: said main flex circuit of claim 9 coupling to said read head for use in creating said pre-contact detection signal.

12. The head stack assembly of claim 11, further comprising: a slider containing said read head providing a read differential signal pair for use in creating said pre-contact detection signal.

13. The head stack assembly of claim 12, wherein said slider further comprises: an amplifier receiving said read differential signal pair to create said read signal presented to said read signal coupling.

14. The head stack assembly of claim 12, wherein said read differential signal pair is presented to said read signal coupling.

15. The head stack assembly of claim 12, further comprising: a flexure finger coupling said slider to said main flex circuit and providing said read signal based upon said read signal pair to said read signal coupling.

16. The head stack assembly of claim 11, further comprising said main flex circuit further coupling to a second of said read heads to provide a second of said read signals used to generate said pre-contact detection signal.

17. The head stack assembly of claim 11, wherein said pre-contact signal detector, further comprises: a multiplexer receiving said read signal and said second read signal to create selected read signal presented used in with said pre-contact filter.

18. The head stack assembly of claim 16, further comprising a second of said pre-contact detectors receiving said second of said read signals to generate a second of said pre-contact detection signal.

19. A method of using said pre-contact detection signal of claim 11 within said hard disk drive, comprising of the step of:
receiving said pre-contact detection signal to create a pre-contact condition presented to a pre-contact alert circuit;
wherein said pre-condition condition is asserted whenever said pre-contact detection signal is active shortly before said read-write head contacts said disk surface;
wherein said method, further comprises at least one member of the group consisting of the steps of:
responding to said pre-contact condition by altering a vertical actuator control signal sent to a vertical micro-actuator causing said slider to alter the vertical position of said slider over said disk surface;
configuring said pre-contact signal detector based upon said pre-contact condition; and
calibrating a preamplifier based upon said pre-contact condition.

20. The method of claim 19,
wherein the step receiving said pre-contact detection signal, further comprises at least one member of the group consisting of the steps of:
digitizing said pre-contact detection signal to at least partly create said pre-contact condition;
level-shifting said pre-contact detection signal to at least partly create said pre-contact condition;
sampling said pre-contact detection signal to at least partly create said pre-contact condition;
wherein the step responding to said pre-contact condition by altering said vertical actuator control signal, further comprises at least one member of the group consisting of:
communicating said pre-contact condition to an embedded circuit directing a vertical driver to alter said vertical actuator control signal sent to said vertical micro-actuator causing said slider to alter said vertical position of said slider over said disk surface; and
communicating said pre-contact condition to a preamplifier containing said vertical driver to alter said vertical actuator control signal sent to said vertical micro-actuator causing said slider to alter said vertical position of said slider over said disk surface.

21. The pre-contact alert circuit, supporting the method of claim 19 includes at least one member of the alert means group consisting of:
means for responding to said pre-contact condition by altering said vertical actuator control signal sent to said vertical micro-actuator causing said slider to alter said vertical position of said slider over said disk surface;
means for configuring said pre-contact signal detector based upon said pre-contact condition; and
means for calibrating a preamplifier based upon said pre-contact condition.

22. The pre-contact detection circuit, further comprising: said pre-contact alert circuit of claim 21 receiving said pre-contact detection signal to create said pre-contact condition.

23. The preamplifier implementing the method of using said pre-contact detection signal, comprising:
said pre-contact alert circuit of claim 21 receiving said pre-contact detection signal to create said pre-contact condition.

24. The preamplifier of claim 23, further comprising said vertical driver generating said vertical actuator control signal.

25. The pre-contact alert circuit of claim 21, includes at least one instance of at least one member of the group consisting of:
a computer responding to said pre-contact condition as directed by a program system to execute program steps residing in an accessibly coupled memory;
a finite state machine receiving said pre-contact condition to create a control state;
a neural network receiving said pre-contact condition to alter at least one member of the group consisting of: a neuron state, and a synaptic connection state;
an inference engine receiving said pre-contact condition to alter at least one member of the group consisting of: a fact, and an inference.

26. The pre-contact alert circuit of claim 25, wherein said computer, includes: at least at least one data processor and at least one instruction processor; wherein each of said data processors is directed by at least one of said instruction processors;
wherein said memory includes at least one instance of at least one member of the group consisting of a non-volatile memory component, and a volatile memory component.

27. The pre-contact alert circuit of claim 25, wherein said program system includes at least one member of the group consisting of the program steps:
responding to said pre-contact condition by altering said vertical actuator control signal sent to said vertical micro-actuator causing said slider to alter said vertical position of said slider over said disk surface;
configuring said pre-contact signal detector based upon said pre-contact condition; and
calibrating a preamplifier based upon said pre-contact condition.

28. An embedded circuit for said hard disk drive and implementing the method of using said pre-contact detection signal, comprising:
said pre-contact alert circuit of claim 25;
a means for receiving said pre-contact detection signal to create a pre-contact condition presented to a pre-contact alert circuit;
wherein said pre-condition condition is asserted whenever said pre-contact detection signal is active shortly before said read-write head contacts said disk surface.

29. The embedded circuit of claim 28, wherein said program system further includes at least one member of the group consisting of the program steps:
positioning said slider to follow a track on said disk surface;
encoding of the data for said read-write head to write as the write data to said track on said disk surface;
writing said write data using said read-write head to said track;
retrieving using said read head the data read from said track; and
decoding said data read by said read head from said track.

30. The hard disk drive using said embedded circuit and said head stack assembly of claim 28, comprising:
said head stack assembly coupled to said embedded circuit to provide said pre-contact detection signal to said means for receiving.

31. A method of manufacturing at least one member of the manufactured product group, consisting of the members: said hard disk drive of claim 30, said embedded circuit, said pre-contact alert circuit, said head stack assembly, said main flex circuit, a preamplifier, said pre-contact signal detector;
wherein said method comprises at least one member of the group consisting of the steps of:
coupling said head stack assembly to said embedded circuit to create said hard disk drive;
providing said means for receiving and said pre-contact alert circuit to create said embedded circuit;
providing at least one said members of said alert means group to create said pre-contact alert circuit;
for each of said read heads included in said head stack assembly, coupling said read head to said main flex circuit to create said head stack assembly;
providing said pre-contact detector to create said main flex circuit; and
providing said pre-contact detector in said preamplifier to create said main flex circuit;
providing said pre-contact signal detector to create said preamplifier, further comprising the step: providing said pre-contact filter and said pre-contact threshold comparator to create said pre-contact signal detector included in said preamplifier; and
providing said pre-contact filter and said pre-contact threshold comparator to create said pre-contact signal detector.

32. The at least one member of said manufactured product group as a product of the process of claim 31.

33. A method of generating a pre-contact detection signal for a hard disk drive, comprising the steps of:
receiving a read signal received from a read head;
pre-contact filtering said read signal to provide a filtered read signal;
comparing said filtered read signal with a pre-contact threshold to create said pre-contact detection signal;
wherein said pre-contact detection signal is active shortly before a read-write head containing said read head contacts a rotating disk surface.

34. The method of claim 33, wherein the step of pre-contact filtering, includes at least one member of the group consisting of:
low pass filtering based upon said read signal with a cut-off frequency to at least partly create said filtered read signal; and
band pass filtering based upon said read signal with a center frequency and a bandwidth to at least partly create said filtered read signal.

35. The method of claim 34, further comprising the step:
controlling said step of pre-contact filtering, further comprising at least one member of the group consisting of the steps of:
providing at least one member of the group consisting of: said cut-off frequency, center frequency, and said bandwidth.

36. The method of claim 35, wherein the step of controlling is directed by an embedded circuit in said hard disk drive.

37. The method of claim 33, further comprising the step of: generating said pre-contact threshold.

38. The method of claim 37, wherein the step of generating said pre-contact threshold is directed by an embedded circuit in said hard disk drive.

39. The method of claim 33, further comprising the step of: amplifying said read signal to create an amplified signal for said step of pre-contact filtering.

40. A method of using said pre-contact detection signal of claim 33 within said hard disk drive, comprising of the step of:
receiving said pre-contact detection signal to create a pre-contact condition presented to a pre-contact alert circuit;
wherein said pre-condition condition is asserted whenever said pre-contact detection signal is active shortly before said read-write head contacts said disk surface;
wherein said method, further comprises at least one member of the group consisting of the steps of:
responding to said pre-contact condition by altering a vertical actuator control signal sent to a vertical micro-actuator causing said slider to alter the vertical position of said slider over said disk surface;
configuring said pre-contact signal detector based upon said pre-contact condition; and
calibrating a preamplifier based upon said pre-contact condition.

41. The method of claim 40,
wherein the step receiving said pre-contact detection signal, further comprises at least one member of the group consisting of the steps of:
digitizing said pre-contact detection signal to at least partly create said pre-contact condition;
level-shifting said pre-contact detection signal to at least partly create said pre-contact condition;
sampling said pre-contact detection signal to at least partly create said pre-contact condition;
wherein the step responding to said pre-contact condition by altering said vertical actuator control signal, further comprises at least one member of the group consisting of:
communicating said pre-contact condition to an embedded circuit directing a vertical driver to alter said vertical actuator control signal sent to said vertical micro-actuator causing said slider to alter said vertical position of said slider over said disk surface; and
communicating said pre-contact condition to a preamplifier containing said vertical driver to alter said vertical actuator control signal sent to said vertical micro-actuator causing said slider to alter said vertical position of said slider over said disk surface.

42. The pre-contact condition as a product of the process of claim 40.

43. The threshold detect as a product of the process of claim 33.
